(19) United States
(12) Patent Application Publication
(10) Pub. No.: US 2026/0351978 A1
(43) Pub. Date: Nov. 5, 2026

(54) ENERGY STORAGE DEVICE

(71) Applicant: SHENZHEN HELLO TECH ENERGY CO., LTD, Shenzhen (CN)

(72) Inventors: Wenhai LIN, Shenzhen (CN); Gaosong SHEN, Shenzhen (CN); Feiyan LUO, Shenzhen (CN)

(21) Appl. No.: 19/726,898

(22) Filed: Jun. 30, 2026

Related U.S. Application Data
(63) Continuation of application No. PCT/CN2025/094893, filed on May 14, 2025.

(51) Int. Cl. H02J 3/32; H02J 3/001; H02J 3/38; H02J 7/00; H02J 7/02; H02J 7/70; H02J 13/183; H02J 13/34; H02J 101/10; H02J 105/12

(52) U.S. Cl. CPC H02J 3/32; H02J 3/001; H02J 3/381; H02J 7/02; H02J 7/751; H02J 7/855; H02J 13/183; H02J 13/34; H02J 2101/10; H02J 2105/12; H02J 2207/20

(57) ABSTRACT

Provided is an energy storage device. The energy storage device includes a housing, a mains power input branch, an energy storage module, and a power distribution module disposed inside the housing. A mains power connection terminal of the mains power input branch is configured to receive mains power. The energy storage module includes a battery module and an inverter. The inverter is configured to convert direct current of the battery module into alternating current and output the alternating current. The power distribution module includes a plurality of output branches. Each of the plurality of output branches includes a power input terminal, a load connection terminal, and a branch switch. The branch switch is disposed between the power input terminal and the load connection terminal to control connection and disconnection of a path therebetween. The branch switch is exposed via an opened outer cover for disassembly, assembly, and operation.

### CROSS-REFERENCE TO RELATED APPLICATION

This application is a continuation of International Patent Application No. PCT/CN2025/094893 filed on May 14, 2025, the entire contents of which are incorporated herein by reference.

### FIELD

The present disclosure relates to the field of energy storage technologies, and more particularly, to an energy storage device.

### BACKGROUND

The household power distribution network generally includes: a main distribution box, mains power, and a generator. After the main distribution box is connected to the mains power or the generator, the main distribution box is connected one by one to a household load via branch switches. In this power distribution network, when the mains power fails, t some critical household loads may fail to operate, affecting normal life. The critical load includes devices such as a refrigerator, a ventilator, and a computer.

To solve the problem that some critical household loads fail to operate and affect normal life when the mains power fails, a currently conventional solution is to separately connect a secondary distribution box and an energy storage power supply in the household power distribution network. Specifically, as illustrated in FIG. 1, after the secondary distribution box is connected to the mains power and the energy storage power supply, the secondary distribution box is connected one by one to the critical household load via branch switches. When the mains power fails, the secondary distribution box may quickly switch from the mains power to the energy storage power supply for power supply, avoiding power interruption to the critical load.

It was recognized that the solution of connecting the secondary distribution box and the energy storage power supply in the household power distribution network has the following problems: (1) it is necessary to drill a hole in a wall to mount the secondary distribution box, which is very cumbersome to operate and requires a large amount of space; (2) it is necessary to open the secondary distribution box to connect a mains port and an energy storage port to a port of the secondary distribution box, and also to connect an electric wire of the critical load into the secondary distribution box, making mounting of the secondary distribution box and the energy storage power supply very cumbersome; (3) multiple products are required to realize power supply for the critical load, which may increase a cost for a user and is not conducive to large-scale promotion of a product.

### SUMMARY

In view of the above problems, the present disclosure aims to solve at least one of the technical problems in the related art to some extent. Therefore, an objective of the present disclosure is to provide an energy storage device.

The present disclosure provides an energy storage device for supplying power to a household load. The energy storage device includes a housing, a mains power input branch, an energy storage module and a power distribution module. The housing have an openable and closable outer cover. The mains power input branch is disposed inside the housing, the mains power input branch including a mains power connection terminal and a first output terminal, and the mains power connection terminal being configured to receive mains power and output the mains power via the first output terminal. The energy storage module is disposed inside the housing, the energy storage module including a battery module and an inverter, and the inverter being configured to convert direct current of the battery module into alternating current and output the converted alternating current via a second output terminal. The power distribution module is disposed inside the housing, the power distribution module including a plurality of output branches, each of the plurality of output branches including a power input terminal, a load connection terminal, and a branch switch. The power input terminal is selectively electrically connectable connected to either the first output terminal or the second output terminal. The load connection terminal is configured to be connected to the household load. The branch switch is detachably disposed between the power input terminal and the load connection terminal to control connection and disconnection of a path therebetween. The branch switch is exposed via an opened outer cover for disassembly, assembly, and operation.

With the energy storage device of the present disclosure, by integrating the energy storage module with a distribution box formed by the mains power input branch and the plurality of output branches, there is no need to drill a hole in the wall to mount the distribution box, which can reduce mounting time. Moreover, wiring and mounting of the household power distribution network is convenient and simple, saving a cost and facilitating large-scale promotion of the energy storage device.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic structural diagram of a household power distribution network in the related art.

FIG. 2 is a schematic structural diagram of a circuit in an energy storage device according to some embodiments of the present disclosure.

FIG. 3 is a schematic structural diagram of a household power distribution network according to some embodiments of the present disclosure.

FIG. 4 is a schematic structural diagram of a circuit in an energy storage device according to some embodiments of the present disclosure.

FIG. 5 is a schematic structural diagram of a circuit in an energy storage device according to some embodiments of the present disclosure.

FIG. 6 is a schematic structural diagram of a circuit in an energy storage device according to some embodiments of the present disclosure.

Description of main reference numerals in the drawings:
energy storage device 100;
housing 10; mains power input branch 20; mains power connection terminal 21; first output terminal 22; single-phase mains power input branch 23; single-phase mains power input terminal 231; single-phase switch 232; single-phase mains power output terminal 233; split-phase mains power input branch 24; split-phase mains power input terminal 241; split-phase switch 242; split-phase mains power output terminal 243; first split-phase output terminal 2431; second split-phase output terminal 2432; energy storage module 30; battery module 31; inverter 32; second output terminal 33; power distribution module 40; output branch 41; power input terminal 411; load connection terminal 412; branch switch 413; generator input branch 50; generator connection terminal 51; generator switch 52; first generator sub-switch 521; second generator sub-switch 522; third generator sub-switch 523; alternating current output terminal 60; alternating current output switch 61; first main switch 70; main control switch 80; second main switch 90; photovoltaic input terminal 91.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative, and are intended to explain, rather than limiting, the present disclosure.

In the description of the present disclosure, the terms such as “first” and “second” are only used for descriptive purposes, and cannot be understood as indicating or implying relative importance or implicitly indicating the number of indicated technical features. Therefore, the features associated with “first” and “second” may explicitly or implicitly include one or more of the features. In the description of the present disclosure, “plurality” means two or more, unless otherwise specifically defined.

In the description of the present disclosure, it should be noted that, unless otherwise clearly stipulated and limited, terms such as “mount” and “connect to” should be understood in a broad sense. For example, it may be a fixed connection, a detachable connection, or connection as one piece; mechanical connection, electrical connection, or mutual communication; direct connection or indirect connection through an intermediate; or internal communication of two components or the interaction relationship between two components. For those skilled in the art, specific meanings of the above-mentioned terms in the present disclosure can be understood according to specific circumstances.

Various embodiments or examples for implementing different structures of the present disclosure are provided below. In order to simplify the description of the present disclosure, components and arrangements of specific examples are described herein. Of course, these specific examples are merely for the purpose of illustration, rather than limiting the present disclosure. Further, the same reference numerals and/or reference letters may appear in different examples of the present disclosure for the purpose of simplicity and clarity, instead of indicating a relationship between the discussed different embodiments and/or the discussed arrangements.

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative, and are intended to explain, rather than limiting, the present disclosure.

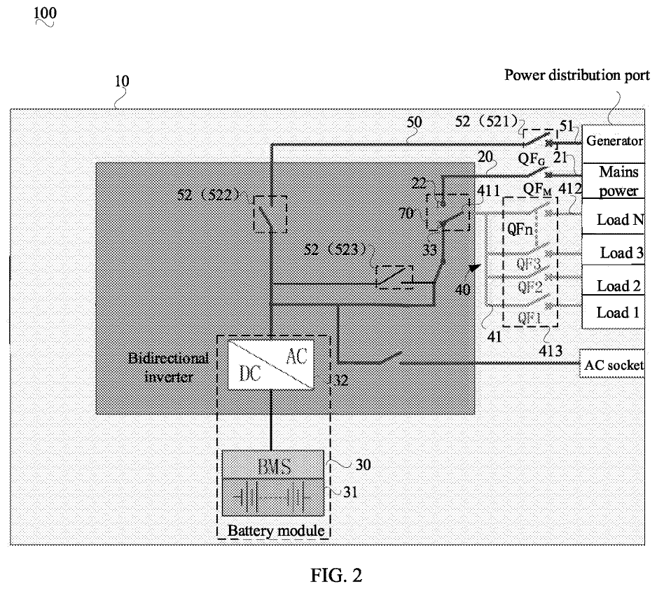

As illustrated in FIG. 2, the present disclosure provides an energy storage device 100. The energy storage device 100 is configured to supply power to a household load. The energy storage device 100 includes a housing 10, a mains power input branch 20, an energy storage module 30, and a power distribution module 40.

The housing 10 has an openable and closable outer cover. For example, the housing 10 is provided with an outer cover configured to be pivotally opened or fixed by a fastener. The fastener may be, for example, a component such as a screw or a bolt, which is not limited herein.

The mains power input branch 20 is disposed inside the housing 10. The mains power input branch 20 includes a mains power connection terminal 21 and a first output terminal 22. The mains power connection terminal 21 is configured to receive mains power and output the mains power via the first output terminal 22.

The energy storage module 30 is disposed inside the housing 10. The energy storage module 30 includes a battery module 31 and an inverter 32. The inverter 32 is configured to convert direct current of the battery module 31 into alternating current and output the converted alternating current via a second output terminal 33. That is, the energy storage device 100 may include a second output terminal 33 electrically connected to the energy storage module 30. The alternating current converted by the inverter 32 from the direct current output by the battery module 31 may be output via the second output terminal 33.

The power distribution module 40 is disposed inside the housing 10. The power distribution module 40 includes a plurality of output branches 41. Each of the plurality of output branches 41 includes a power input terminal 411, a load connection terminal 412, and a branch switch 413. The power input terminal 411 is electrically connected to the first output terminal 22 or the second output terminal 33. The load connection terminal 412 is configured to be connected to the household load. The branch switch 413 is detachably disposed between the power input terminal 411 and the load connection terminal 412 to control connection and disconnection of a path therebetween. The branch switch 413 is exposed via an opened outer cover for disassembly, assembly, and operation. The household load includes, for example, a device such as a refrigerator, an air conditioner, or a computer.

That is, the energy storage device 100 of the present disclosure includes not only the energy storage module 30, but also the mains power input branch 20 and the power distribution module 40. The mains power input branch 20 is used for input and output of mains power, to enable control of electric energy from the mains power. The power distribution module 40 includes the plurality of output branches 41. Each output branch 41 includes a power input terminal 411, a load connection terminal 412, and a branch switch 413. The power input terminal 411 is selectively electrically connected to the first output terminal 22 of the mains power input branch 20 or the second output terminal 33 of the energy storage module 30, to realize switching control of power supply to a load connected to the load connection terminal 412 between the mains power and the energy storage module 30. The branch switch 413 is disposed between the power input terminal 411 and the load connection terminal 412 to control the connection and disconnection of the path therebetween, to enable distribution, control, and protection of electric energy supplied to the load. Therefore, a plurality of loads of the present disclosure can be simultaneously connected to the energy storage device 100 via a power distribution port formed by a plurality of load connection terminals 412.

For example, the branch switch 413 may be a circuit breaker. When current between the load connection terminal 412 and the load is too large, the branch switch 413 may control the path between the power input terminal 411 and the load connection terminal 412 to be disconnected. As illustrated in FIG. 2, the energy storage device 100 may have N loads. Correspondingly, N circuit breakers are provided, which are QF1, QF2, QF3, . . . QFn. One circuit breaker is connected to one corresponding load. In this way, the energy storage device of the present disclosure can be connected to multiple load paths. Each load path is provided with a branch switch 413 for independent output control. When the multiple load devices need to be supplied power simultaneously, the multiple load devices may be directly connected to the plurality of load connection terminals 412 of the energy storage device 100, eliminating the need for the user to use an adapter accessory such as a socket to expand a number of a power output port of the energy storage device 100.

In addition, when the current between the load connection terminal 412 and the load is too large, the branch switch 413 may automatically disconnect, enabling the path between the power input terminal 411 and the load connection terminal 412 to be disconnected, thereby preventing the circuit and the device from being damaged due to overheating. Therefore, since the branch switch 413 is provided for circuit protection, stability and safety of power transmission in the energy storage device 100 are unaffected while multiple loads are connected.

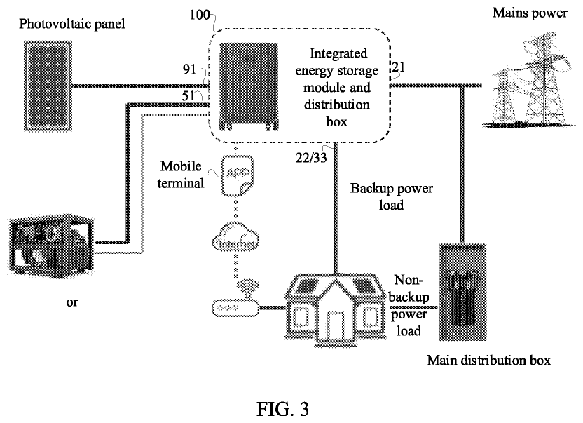

Therefore, by providing the mains power input branch 20 and the power distribution module 40 in the energy storage device 100, a function of a distribution box can be realized. In other words, the present disclosure provides an energy storage device 100 formed by integrating the energy storage module 30 with a distribution box constituted by the mains power input branch 20 and the power distribution module 40, as illustrated in FIG. 3.

In addition, as illustrated in FIG. 2, the energy storage device 100 of the present disclosure mainly includes the housing 10, the battery module 31, the inverter 32, and the power distribution module 40. The battery module 31, the inverter 32, and the power distribution module 40 are disposed inside the housing 10. The housing 10 is provided with an openable outer cover. The outer cover is similar to a front cover of the distribution box. The openable outer cover may facilitate disassembly, assembly, or operation of the branch switch 413. For example, if the user intends to disconnect a predetermined branch switch 413, an outer cover at a position corresponding to the power distribution module 40 may be opened to operate and disconnect the corresponding branch switch 413.

It should be understood that since the branch switch 413 is detachably disposed between the power input terminal 411 and the load connection terminal 412, the energy storage device 100 of the present disclosure may not be equipped with the branch switch 413. A user may purchase the branch switch 413 separately, or remove a circuit breaker from an original household distribution box and mount the circuit breaker on the energy storage device 100 of the present disclosure to serve as the branch switch 413. In this way, the energy storage device 100 is lighter and easy to carry. Specifically, the circuit breaker from the original household distribution box may be mounted on the power distribution module 40 of the energy storage device 100 in a plug-in manner. That is, a plug-in port is exposed after opening the outer cover at the position corresponding to the power distribution module 40, and the circuit breaker may be directly plugged into the plug-in port of the power distribution module 40 for use. In this case, the circuit breaker may be mounted on the power distribution module 40 and function as the branch switch 413.

In this way, the energy storage device 100 of the present disclosure integrates the energy storage module 30 with the distribution box constituted by the mains power input branch 20 and the power distribution module 40. As a result, a mounting space for the distribution box in the household power distribution network can be reduced, eliminating a need to drill the hole in the wall to mount the distribution box, and shortening mounting time. In addition, an electric wire of a critical load can be directly connected to the load connection terminal 412, and the mains power can be directly connected to the mains power connection terminal 21. Wiring and mounting of the household power distribution network is convenient and simple, saving the cost and thus facilitating the large-scale promotion of the energy storage device 100.

As illustrated in FIG. 2 and FIG. 3, in some embodiments, the branch switch 413 is communicatively connectable to a mobile terminal. The mobile terminal is configured to control an on-off state of the branch switch 413. Alternatively, the energy storage device 100 is communicatively connectable to the mobile terminal. The energy storage device 100 is configured to control the on-off state of the branch switch 413 based on a switch control signal sent by the mobile terminal.

When the branch switch 413 is communicatively connected to the mobile terminal, the branch switch 413 serves as a smart circuit breaker.

That is, the smart circuit breaker may be mounted for each load path. The mobile terminal is communicatively connected to each smart circuit breaker. Alternatively, an application program for controlling on-off state of multiple smart circuit breakers may be installed on the mobile terminal. The energy storage device 100 of the present disclosure may perform data monitoring and transmission on an output parameter of a circuit branch where each smart circuit breaker is located through the mobile terminal. The output parameter may include, for example, current, voltage, or other parameters, so that the mobile terminal can remotely control the on-off state of each smart circuit breaker.

In some embodiments, the energy storage device 100 is communicatively connected to the mobile terminal. The energy storage device 100 is configured to control the on-off state of the branch switch 413 based on the switch control signal sent by the mobile terminal.

That is, the mobile terminal is only communicatively connected to the energy storage device 100. After receiving the switch control signal sent by the mobile terminal, the energy storage device 100 then controls the on-off state of the branch switch 413 based on the switch control signal. The switch control signal may be an electrical signal for controlling one or more branch switches to be turned on or off. In the present disclosure, by establishing a communicative connection between the energy storage device 100 and the mobile terminal, remote control of the on-off state of each branch switch 413 by the mobile terminal can be realized.

In this way, the user may remotely control opening and closing of the branch switch 413 via the mobile terminal, to remotely control parameters such as the number of the load connected to the energy storage device 100 and the current, which is more convenient and helps improve user experience.

In some embodiments, the inverter 32 is a bidirectional inverter. The mains power received at the mains power connection terminal is supplied to the battery module 31 through the inverter.

That is, the energy storage device 100 of the present disclosure may further be provided with a bidirectional inverter. The bidirectional inverter performs conversion between direct current and alternating current inside the energy storage device 100, to realize charging or discharging of the battery module 31 inside the energy storage device 100.

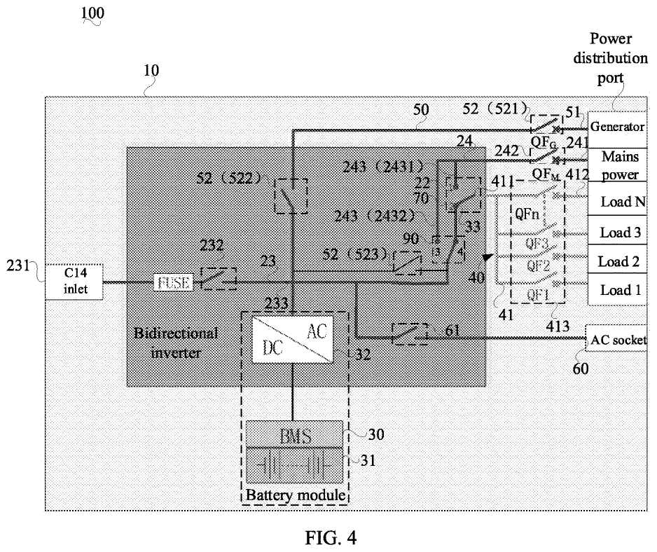

As illustrated in FIG. 4, in some embodiments, the mains power input branch 20 includes: a single-phase mains power input branch 23 configured for single-phase mains power charging of the energy storage module 30; and a split-phase mains power input branch 24 configured for split-phase mains power charging of the energy storage module 30. The energy storage module 30 is operable to be charged via the single-phase mains power charging or the split-phase mains power charging.

That is, the energy storage device 100 of the present disclosure is internally provided with the single-phase mains power input branch 23 and the split-phase mains power input branch 24, and may be charged with the single-phase mains power or the split-phase mains power, diversifying a charging mode.

In some embodiments, the split-phase mains power input branch 24 is electrically connected to the first output terminal 22. The single-phase mains power input branch 23 is electrically connected to the second output terminal 33. When both the first output terminal 22 and the second output terminal 33 output power, the power input terminal 411 is electrically connected to the first output terminal 22.

That is, the energy storage device 100 of the present disclosure may output the split-phase mains power from the first output terminal 22 via the split-phase mains power input branch 24, and output the single-phase mains power from the second output terminal 33 via the single-phase mains power input branch 23. When the first output terminal 22 outputs the split-phase mains power and the second output terminal 33 outputs the single-phase mains power simultaneously, the power input terminal 411 may be controlled to be electrically connected to the first output terminal 22, such that the energy storage device 100 preferentially outputs the split-phase mains power to supply the split-phase mains power to the load.

In some embodiments, the energy storage device 100 further includes a first alternating current bus. The energy storage module 30 and the single-phase mains power input branch 23 are electrically connected to the second output terminal 33 via the first alternating current bus.

It should be understood that an alternating current bus is a key conductive component for centralized distribution of alternating current in a power system. The alternating current bus is usually made of copper or aluminum, and features high electrical conductivity and mechanical strength.

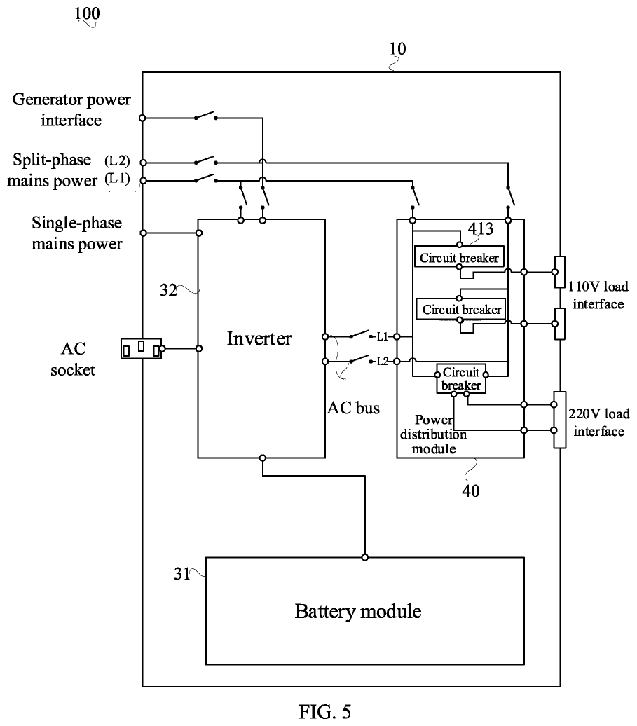

In an exemplary embodiment of the present disclosure, the first alternating current bus may include one live wire. The first alternating current bus may be a live wire L1 or a live wire L2 as shown in FIG. 5. When the load connected to the energy storage device 100 is a 110V load, a single live wire (L1 or L2) may be connected to the branch switch 413, and then the branch switch 413 is connected to the load.

In this way, in an interior of the energy storage device 100 of the present disclosure, connection between the energy storage module 30 and the second output terminal 33, and connection between the single-phase mains power input branch 23 and the second output terminal 33 can be realized via the alternating current bus, thereby realizing distribution of alternating current output by the energy storage module 30 and the single-phase mains power.

In some embodiments, the energy storage device 100 further includes a second alternating current bus. The energy storage module 30 and the split-phase mains power input branch 24 are electrically connected to the second output terminal 33 via the second alternating current bus.

In an exemplary embodiment of the present disclosure, the second alternating current bus may include two live wires. The second alternating current bus may be L1 and L2 as shown in FIG. 5. If a household load includes the 110V load and a 220V load, the 110V load only needs to be connected to the energy storage device 100 via the single live wire (L1 or L2 shown in FIG. 5), while the 220V load is connected to the energy storage device 100 via two live wires L1 and L2. In addition, alternating currents of the live wire L1 and the live wire L2 have a phase difference of 180°. The phase difference of 180°between the alternating currents of the two live wires L1 and L2 means that voltage waveforms thereof are completely opposite in time. When a voltage of L1 reaches a positive peak, a voltage of L2 just reaches a negative peak, and vice versa.

In this case, the inverter 32 is a split-phase inverter. The inverter 32 may output a 110V voltage or a 220V voltage. When the load connected to the energy storage device 100 is a 110V load, the single live wire (L1 or L2) is connected to the branch switch 413 and then to the 110V load. When the load connected to the energy storage device 100 is a 220V load, two live wires (L1 and L2) are connected to the branch switch 413 and then to the 220V load.

As illustrated in FIG. 4, in some embodiments, the single-phase mains power input branch 23 further includes a single-phase mains power input terminal 231 and a single-phase mains power output terminal 233. The single-phase mains power input terminal 231 is configured to receive the single-phase mains power. The single-phase mains power output terminal 233 is configured to output the single-phase mains power to charge the energy storage module 30. The split-phase mains power input branch 24 further includes a split-phase mains power input terminal 241 and a split-phase mains power output terminal 243. The split-phase mains power output terminal 243 includes a first split-phase output terminal 2431 and a second split-phase output terminal 2432. The first split-phase output terminal 2431 is electrically connected to the first output terminal 22. The second split-phase output terminal 2432 is configured to output the split-phase mains power to charge the energy storage module 30. The single-phase mains power input terminal 231 may be an IEC C14 power inlet as shown in FIG. 4.

That is, the energy storage device 100 of the present disclosure may receive the single-phase mains power via the single-phase mains power input terminal 231 of the single-phase mains power input branch 23 to charge the energy storage module 30. The energy storage device 100 of the present disclosure may also receive the split-phase mains power via the split-phase mains power input terminal 241 of the split-phase mains power input branch 24 and charge the energy storage module 30 via the second split-phase output terminal 2432.

In addition, the energy storage device 100 of the present disclosure may be electrically connected to the first output terminal 22 via the first split-phase output terminal 2431, to enable the energy storage device 100 to output the split-phase mains power to supply the split-phase mains power to the load.

In some embodiments, the energy storage device 100 further includes a control module (not illustrated). The single-phase mains power input branch 23 further includes a single-phase switch 232. The single-phase switch 232 has an end connected to the single-phase mains power input terminal 231, and another end connected to the single-phase mains power output terminal 233. The control module is configured to control the single-phase switch 232 to turn on when the single-phase mains power is received at the single-phase mains power input terminal 231. The split-phase mains power input branch 24 further includes a split-phase switch 242. The split-phase switch 242 has an end connected to the split-phase mains power input terminal 241, and another end connected to the split-phase mains power output terminal 243. The control module is further configured to control the split-phase switch 242 to turn on when the split-phase mains power is received at the split-phase mains power input terminal 241.

That is, when the single-phase mains power is connected to the energy storage device 100, the control module may control the single-phase switch 232 to turn on, enabling the energy storage module 30 to be charged via the single-phase mains power input branch 23. When the energy storage device 100 is fully charged, the control module may control the single-phase switch 232 to turn off to prevent overcharging of the energy storage module 30. It should be noted that the single-phase switch 232 is also in an off state when no single-phase mains power is connected to the energy storage device 100.

In addition, when the split-phase mains power is connected to the energy storage device 100 of the present disclosure, the control module may control the split-phase switch 242 to turn on, enabling the energy storage module 30 to be charged via the split-phase mains power input branch 24. When the energy storage device 100 is fully charged, the control module may control the split-phase switch 242 to turn off to prevent overcharging of the energy storage module 30. It should be noted that the split-phase switch 242 is also in the off state when no split-phase mains power is connected to the energy storage device 100.

As illustrated in FIG. 2 or FIG. 4, in some embodiments, the energy storage device 100 further includes a generator input branch 50. The generator input branch 50 has a generator connection terminal 51. The generator input branch 50 is configured to receive generator power via the generator connection terminal 51 to charge the energy storage module 30 or transmit power to the second output terminal 33.

In an exemplary embodiment of the present disclosure, a generator serves as a backup power source. The generator may be, for example, a diesel generator or a gasoline generator.

On one hand, that the generator input branch 50 receives the generator power via the generator connection terminal 51 to charge the energy storage module 30 means that the generator may be connected to the generator connection terminal 51, and the generator may input power to charge the energy storage module 30 via the generator input branch 50. In other words, in the present disclosure, when the mains power connected to the energy storage device 100 fails, the generator may supply emergency power to the energy storage device 100 to realize charging of the energy storage module 30 by the generator.

On the other hand, that the generator input branch 50 receives the generator power via the generator connection terminal 51 and transmits power to the second output terminal 33 means that the energy storage module 30 may output power from the second output terminal 33 by using the generator power input from the generator. When the power input terminal 411 is electrically connected to the second output terminal 33, the power output from the second output terminal 33 may supply power to the load connected to the load connection terminal 412 that is connected to the power input terminal 411, realizing discharging of the energy storage module 30.

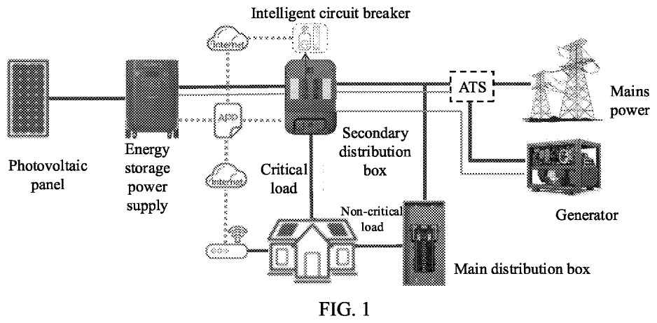

It should be understood that in the related art, as illustrated in FIG. 1, the generator is an important form of backup power supply and is suitable for a scenario requiring long-time and high-power emergency power supply. However, it requires an Automatic Transfer Switch (ATS) to enable automatic switching. Therefore, the household power distribution network in the related art additionally needs an external ATS for the generator to realize connection of the generator to the energy storage device 100, which leads to a high connection cost and a relatively complicated process.

In contrast, the energy storage device 100 of the present disclosure may be directly connected to the generator via the generator connection terminal 51, and utilize the generator power to charge the energy storage module 30 or transmit the power to the second output terminal 33 for external discharging, as shown in FIG. 3. No external ATS is required, and generator connection is more convenient, saving a cost of the external ATS, and realizing intelligent management of multiple energy sources.

As illustrated in FIG. 2 or FIG. 4, in some embodiments, the generator input branch 50 further includes a generator switch 52. The generator switch 52 has an end electrically connected to the generator connection terminal 51, and another end connected to the energy storage module 30 or the second output terminal 33.

In this way, the energy storage device 100 of the present disclosure may control on-off state of the generator switch 52, to control the energy storage device 100 to receive the generator power via the generator connection terminal for charging the energy storage module 30 or transmitting the power to the second output terminal 33.

In some embodiments, the energy storage device 100 includes the control module connected to a generator switch 52. The control module is configured to control the generator switch 52 to turn on or turn off when a generator is connected to the generator connection terminal 51.

In an exemplary embodiment of the present disclosure, as illustrated in FIG. 4, the generator switch 52 may include a first generator sub-switch 521, a second generator sub-switch 522, and a third generator sub-switch 523. When the first generator sub-switch 521 and the second generator sub-switch 522 turn on and the third generator sub-switch 523 turns off, the energy storage device 100 of the present disclosure receives the generator power via the generator connection terminal to charge the energy storage module 30.

When all of the first generator sub-switch 521, the second generator sub-switch 522, and the third generator sub-switch 523 turn on, the energy storage device 100 of the present disclosure receives the generator power via the generator connection terminal 51 and transmits the power to the second output terminal 33.

In this way, the energy storage device 100 of the present disclosure may control on-off states of the first generator sub-switch 521, the second generator sub-switch 522, and the third generator sub-switch 523, to control the energy storage device 100 to receive the generator power via the generator connection terminal for charging the energy storage module 30 or transmitting the power to the second output terminal 33.

It should be noted that the first generator sub-switch 521 may be a QF generator shown in FIG. 4, and the first generator sub-switch 521 may also be a circuit breaker, which is not limited herein. That is, when all of the first generator sub-switch 521, the second generator sub-switch 522, and the third generator sub-switch 523 turn on, the first generator sub-switch 521 may control a path between the generator connection terminal 51 and the energy storage module 30 or the power input terminal 411 to be disconnected when current between the generator connection terminal 51 and the generator is excessive.

As illustrated in FIG. 2 or FIG. 4, in some embodiments, the energy storage device 100 further includes an alternating current output terminal 60. The energy storage module 30 is configured to transmit the alternating current to the alternating current output terminal 60.

In an exemplary embodiment of the present disclosure, the alternating current output terminal 60 may be an energy storage AC socket. The energy storage device 100 may be connected to an external device via the energy storage AC socket, to transmit the alternating current to the external device. The external device may be, for example, a computer, a lighting device, and the like, which is not limited herein.

In some embodiments, the energy storage device 100 further includes an alternating current output switch 61. The alternating current output switch 61 has an end electrically connected to the alternating current output terminal 60, and another end connected to the energy storage module 30. That is, the energy storage device 100 of the present disclosure may be provided with the alternating current output switch 61 to control connection and disconnection of alternating current output from the energy storage device 100 to the external device.

In some embodiments, the energy storage device 100 further includes a control module electrically connected to the alternating current output switch 61. The control module is configured to control the alternating current output switch 61 to turn on when the external device is connected to the alternating current output terminal 60.

That is, when an external device is connected to the alternating current output terminal 60 of the energy storage device 100 of the present disclosure, the control module may control the alternating current output switch 61 to turn on, so that the energy storage module 30 can supply the alternating current to the external device. When no external device is connected to the alternating current output terminal 60, the control module may control the alternating current output switch 61 to turn off.

Alternatively, when the external device is connected to the alternating current output terminal 60 and remaining power of the energy storage module 30 is insufficient, the control module controls the alternating current output switch 61 to turn off, to avoid over-discharging or invalid discharging of the energy storage module 30.

In this way, the control module can control turn-on and turn-off of the alternating current output switch 61 to realize intelligent control over alternating current output of the energy storage device 100, making the energy storage device 100 safer and more intelligent.

As illustrated in FIG. 2 or FIG. 4, in some embodiments, the energy storage device 100 further includes a first main switch 70. The first main switch 70 has an end electrically connected to the power input terminal 411, and another end selectively connectable to either the first output terminal 22 or the second output terminal 33.

That is, in addition to providing the branch switch 413 on the output branch 41, the energy storage device 100 of the present application may further provide the first main switch 70 between the power input terminal 411 and the first output terminal 22 and the second output terminal 33.

When one end of the first main switch 70 is electrically connected to the power input terminal 411, and the other end of the first main switch 70 is connected to the first output terminal 22, the power input terminal 411 is electrically connected to the first output terminal 22. When one end of the first main switch 70 is electrically connected to the power input terminal 411, and the other end of the first main switch 70 is electrically connected to the second output terminal 33, the power input terminal 411 is electrically connected to the second output terminal 33. In other words, the first main switch 70 may be a single-pole double-throw switch. The first main switch 70 is configured to control the power to be output from the first output terminal 22 or the second output terminal 33.

In this way, by providing the first main switch 70, the energy storage device 100 of the present disclosure enables the power input terminal 411 to be selectively electrically connected to either the first output terminal 22 or the second output terminal 33.

As illustrated in FIG. 2 or FIG. 4, in some embodiments, the energy storage device 100 further includes a control module. The control module is configured to control the first main switch 70 to be electrically connected to the second output terminal 33 when power fails at the first output terminal 22.

That is, when the mains power connected to the mains power connection terminal 21 is de-energized, resulting in a power failure at the first output terminal 22, the control module may automatically control the first main switch 70 to be electrically connected to the second output terminal 33. In this way, switchover from supplying an external load with the mains power to supplying the external load with alternating current output from the energy storage module 30 via the second output terminal 33 can be realized.

In other words, the energy storage device 100 of the present disclosure may be connected to a mains power supply. By controlling turn-on and turn-off of the first main switch 70, uninterrupted load transfer between the mains power supply to the load and power supply from the energy storage module 30 to the load within a predetermined duration can be realized. The predetermined duration may be, for example, 20 ms or other values, which is not limited herein.

As illustrated in FIG. 2 or FIG. 4, in some embodiments, the energy storage device 100 further includes a control module. The control module is configured to control the first main switch 70 to be electrically connected to the second output terminal 33 when an electric quantity of the battery module 31 is greater than a predetermined threshold.

In an exemplary embodiment of the present disclosure, the predetermined threshold may be a rated electric quantity of the battery module 31 or a predetermined electric quantity value, which is not limited herein.

That is, in some embodiments of the present disclosure, the energy storage device 100 may further charge the battery module 31 inside the energy storage module 30 via a solar photovoltaic panel. When the energy storage module 30 is fully charged, that is, when the electric quantity of the battery module 31 is greater than the predetermined threshold, the control module may automatically control the first main switch 70 to be electrically connected to the second output terminal 33. In this way, switchover from supplying the external load with the mains power to supplying the external load with the alternating current output from the energy storage module 30 via the second output terminal 33 can be realized, thereby avoiding waste of electric energy generated by the solar photovoltaic panel and reducing electricity costs from mains power consumption.

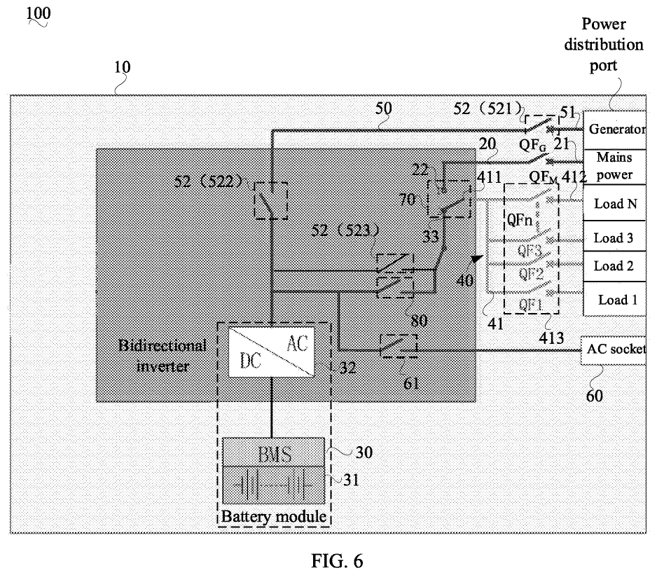

As illustrated in FIG. 6, in some embodiments, the energy storage device 100 further includes a main control switch 80. The main control switch 80 has an end electrically connected to the first main switch 70, and another end electrically connected to the energy storage module 30.

In this way, the energy storage device 100 of the present disclosure may control, via the main control switch 80, the energy storage module 30 to discharge externally or stop external discharging.

In some embodiments, the energy storage device 100 further includes a control module. The control module is configured to control the main control switch 80 to turn on when the electric quantity of the battery module 31 is greater than the first predetermined threshold, and to control the main control switch 80 to turn off when the electric quantity of the battery module 31 is smaller than or equal to a second predetermined threshold.

In an exemplary embodiment of the present disclosure, the first predetermined threshold may be the rated electric quantity of the battery module 31 or a predetermined electric quantity value, which is not limited herein. The second predetermined threshold may be 5%, 6%, or 7% of the rated electric quantity of the battery module 31, which is not limited herein.

In this way, in the energy storage device 100 of the present disclosure, when the electric quantity of the battery module 31 is greater than the first predetermined threshold, the control module may control the main control switch 80 to turn on, so that alternating current converted by the inverter 32 from direct current output by the battery module 31 may pass through the first main switch 70 in the on state and be output via the second output terminal 33. In addition, in the energy storage device 100 of the present disclosure, when the electric quantity of the battery module 31 is smaller than or equal to the second predetermined threshold, the control module may control the main control switch 80 to turn off, which can prevent over-discharging of the energy storage device 100.

As illustrated in FIG. 4, on the basis that the first main switch 70 is provided, the mains power input branch 20 of the present disclosure may also include the single-phase mains power input branch 23 and the split-phase mains power input branch 24.

In some embodiments, the mains power input branch 20 includes the single-phase mains power input branch 23 configured for single-phase mains power charging of the energy storage module 30. The single-phase mains power input branch 23 further includes a single-phase mains power input terminal 231 and a single-phase mains power output terminal 233. The single-phase mains power input terminal 231 is configured to receive single-phase mains power. The single-phase mains power output terminal 233 is configured to output the single-phase mains power to charge the energy storage module 30.

The energy storage device 100 further includes a control module. The single-phase mains power input branch 23 further includes a single-phase switch 232. The single-phase switch 232 has an end connected to the single-phase mains power input terminal 231, and another end connected to the single-phase mains power output terminal 233. The control module is configured to control the single-phase switch 232 to turn on when the single-phase mains power is received at the single-phase mains power input terminal 231.

In some embodiments, the mains power input branch 20 includes a split-phase mains power input branch 24. The split-phase mains power input branch 24 includes a split-phase mains power input terminal 241 and a split-phase mains power output terminal 243. The split-phase mains power input terminal 241 is configured to receive split-phase mains power. The split-phase mains power output terminal 243 includes a first split-phase output terminal 2431 and a second split-phase output terminal 2432. The first split-phase output terminal 2431 is electrically connected to the first output terminal 22. The second split-phase output terminal 2432 is configured to output the split-phase mains power to charge the energy storage module 30.

The energy storage device 100 further includes a control module. The split-phase mains power input branch 24 further includes a split-phase switch 242. The split-phase switch 242 has an end connected to the split-phase mains power input terminal 241, and another end connected to the split-phase mains power output terminal 243. The control module is configured to control the split-phase switch 242 to turn on when the split-phase mains power is received at the split-phase mains power input terminal 241. The split-phase switch 242 may be a QF circuit breaker shown in FIG. 4.

In an exemplary embodiment of the present disclosure, structures of the single-phase mains power input branch 23 and the split-phase mains power input branch 24 are as described above, and will not be repeated herein.

As illustrated in FIG. 4, the energy storage device 100 further includes a second main switch 90. The second main switch 90 has an end electrically connected to the inverter 32, and another end selectively connectable to either the second split-phase output terminal 2432 or the second output terminal 33.

When the split-phase mains power connected to the energy storage device 100 is normal, split-phase mains power is output from the second split-phase output terminal 2432. In this case, one end of the second main switch 90 is electrically connected to the inverter 32, and the other end of the second main switch 90 is connected to the second split-phase output terminal 2432. The energy storage module 30 may convert the split-phase mains power into direct current required by the battery module 31 through the inverter 32. The energy storage module 30 may be charged via the second split-phase output terminal 2432. Meanwhile, if the second split-phase output terminal 2432 is energized, and split-phase mains power is also output from the first split-phase output terminal 2431, the first main switch 70 may be connected to the first split-phase output terminal 2431. The split-phase mains power output from the first split-phase output terminal 2431 may supply power to the power distribution module 40. In this case, there is no need to connect the inverter 32 to the second output terminal 33, and the load connected to the load connection terminal 412 is supplied with the connected split-phase mains power.

When the split-phase mains power connected to the energy storage device 100 is de-energized, no split-phase mains power is output from the second split-phase output terminal 2432. In this case, one end of the second main switch 90 is electrically connected to the inverter 32, and the other end of the second main switch 90 is connected to the second output terminal 33. In this case, the first main switch 70 is also electrically connected to the second output terminal 33. Therefore, direct current in the energy storage module 30 of the energy storage device 100 can be converted into alternating current by the inverter 32 and then supplied to the power distribution module 40 via the second output terminal 33, so that the energy storage module 30 can provide power for the load connected to the load connection terminal 412.

In this way, by controlling turn-on and turn-off of the first main switch 70 and the second main switch 90, the energy storage device 100 of the present disclosure can realize the charging or discharging of the energy storage module 30.

In some embodiments, the energy storage device 100 further includes a control module. The control module is configured to: control the second main switch 90 to be electrically connected to the second output terminal 33 when power fails at the split-phase mains power output terminal 243; or control the second main switch 90 to be electrically connected to the second output terminal 33 when an electric quantity of the battery module 31 is greater than a predetermined threshold.

In an exemplary embodiment of the present disclosure, when the split-phase mains power output terminal 243 suffers an abrupt power outage, that is, power suddenly fails at the first split-phase output terminal 2431 and the second split-phase output terminal 2432, the energy storage device 100 may be electrically connected to the second output terminal 33 via the second main switch 90. In addition, since the first split-phase output terminal 2431 is electrically connected to the first output terminal 22, that is, power also fails at the first output terminal 22, the first main switch 70 is electrically connected to the second output terminal 33. In this case, the energy storage module 30 inside the energy storage device 100 may supply power to the load connected to the load connection terminal 412 via the second output terminal 33, realizing external discharging of the energy storage device 100.

That is, when the split-phase mains power connected to the split-phase mains power input terminal 241 is de-energized, resulting in a power failure at the split-phase mains power output terminal 243, the control module may automatically control the second main switch 90 to be electrically connected to the second output terminal 33. In this case, the first main switch 70 can also be electrically connected to the second output terminal 33. In this way, switchover from supplying the external load with split-phase mains power to supplying the external load with alternating current output from the energy storage module 30 via the second output terminal 33 can be realized.

In other words, the energy storage device 100 of the present disclosure may be connected to the mains power supply. By controlling the on-off state of the second main switch 90 and the first main switch 70, uninterrupted load transfer between mains power supply to the load and power supply from the energy storage module 30 to the load within a predetermined duration can be realized. The predetermined duration may be, for example, 20 ms or other values, which is not limited herein.

In some embodiments, the energy storage device 100 further includes a control module. The control module is configured to control the second main switch 90 to be electrically connected to the second output terminal 33 when an electric quantity of the battery module 31 is greater than a predetermined threshold.

In an exemplary embodiment of the present disclosure, when the electric quantity of the battery module 31 is greater than the predetermined threshold, the energy storage device 100 may be electrically connected to the second output terminal 33 via the second main switch 90. In addition, since the first split-phase output terminal 2431 is electrically connected to the first output terminal 22, the first main switch 70 is electrically connected to the second output terminal 33. In this case, the energy storage module 30 inside the energy storage device 100 may supply power to the load connected to the load connection terminal 412 via the second output terminal 33, realizing the external discharging of the energy storage device 100.

The predetermined threshold may be the rated electric quantity of the battery module 31 or the predetermined electric quantity value, which is not limited herein.

That is, in some embodiments of the present disclosure, the energy storage device 100 may further charge the battery module 31 in the energy storage module 30 via the solar photovoltaic panel. When the energy storage module 30 is fully charged, that is, when the electric quantity of the battery module 31 is greater than the predetermined threshold, the control module may automatically control the second main switch 90 to be electrically connected to the second output terminal 33, and the first main switch 70 to be electrically connected to the second output terminal 33. In this way, switchover from supplying the external load with the mains power to supplying the external load with the alternating current output from the energy storage module 30 via the second output terminal 33 can be realized, thereby avoiding waste of electric energy generated by the solar photovoltaic panel, and reducing electricity costs from mains power consumption.

As illustrated in FIG. 4 and FIG. 5, in some embodiments, the mains power input branch 20 includes a split-phase mains power input branch 24. The inverter 32 is a split-phase inverter. The split-phase mains power input branch 24 is electrically connected to the first output terminal 22. The split-phase inverter is electrically connected to the second output terminal 33.

That is, when split-phase mains power is input to the split-phase mains power input branch 24, the split-phase mains power input through the split-phase mains power input branch 24 may be output to a load side via the first output terminal 22 to supply the split-phase mains power to the load.

When no split-phase mains power is input to the split-phase mains power input branch 24, the split-phase inverter is electrically connected to the second output terminal 33, and may output a voltage of 110 V or 220 V. When the connected load is a 110 V load, it is connected to the single live wire (L1 or L2) via the branch switch 413, and split-phase alternating current is output via the second output terminal 33 to supply power to the load. When the connected load is a 220 V load, it is connected to two live wires (L1 and L2) via the branch switch 413, and split-phase alternating current is output via the second output terminal 33 to supply power to the load.

It should be understood that when mains power fails, if only single-phase power is output from the second output terminal 33, the inverter 32 cannot meet a power supply demand of the 220 V load. Therefore, in the present disclosure, the split-phase inverter is provided. Split-phase alternating current converted by the split-phase inverter is output via the second output terminal 33 to supply power to the 220 V load, solving the problem that the inverter 32 cannot meet the power supply demand of the 220 V load.

In some embodiments, as illustrated in FIG. 3, the energy storage device 100 further includes a photovoltaic input terminal 91. The photovoltaic input terminal 91 has an end connected to a photovoltaic module, and another end connected to the battery module 31. The photovoltaic input terminal 91 is configured to receive electric energy generated by the photovoltaic module and store the electric energy into the battery module 31.

That is, the energy storage device 100 of the present disclosure may also be provided with the photovoltaic input terminal 91. The photovoltaic input terminal 91 is configured to receive electric energy generated by the photovoltaic module and store the electric energy in the battery module 31, to realize utilization of photovoltaic energy, which is energy-saving and environmentally friendly.

The above embodiments only illustrate several implementation modes of the present disclosure, and the descriptions thereof are relatively specific and detailed, but shall not be construed as limiting the scope of the present disclosure. It should be noted that several variations and improvements can be made by those of ordinary skill in the art without departing from the concept of the present disclosure, all of which fall within the protection scope of the present disclosure. Therefore, the protection scope of the present disclosure shall be subject to the appended claims.

What is claimed is:

1. An energy storage device for supplying power to a load, comprising:
a housing;
a mains power input branch disposed inside the housing, wherein the mains power input branch comprises a mains power connection terminal configured to receive mains power;
an energy storage module disposed inside the housing, wherein the energy storage module comprises a battery module and an inverter, the inverter being configured to convert direct current of the battery module into alternating current and output the alternating current; and
a power distribution module disposed inside the housing, wherein the power distribution module comprises a plurality of output branches, each of the plurality of output branches comprising a power input terminal, a load connection terminal, and a branch switch, wherein the power input terminal is configured to receive the alternating current output from the energy storage module or the mains power, the load connection terminal is configured to be connected to the load, and the branch switch is disposed between the power input terminal and the load connection terminal and is configured to control connection and disconnection of a path between the power input terminal and the load connection terminal, and wherein the branch switch is configured to be communicatively connected to a mobile terminal, the mobile terminal being configured to control an on-off state of the branch switch, or the energy storage device is configured to be communicatively connected to the mobile terminal, the energy storage device being configured to control the on-off state of the branch switch based on a switch control signal sent by the mobile terminal.

2. The energy storage device according to claim 1, wherein:
the mains power received at the mains power connection terminal is output via a first output terminal, the alternating current converted by the inverter from the direct current of the battery module is output via a second output terminal, wherein the power output terminal is selectively electrically connectable to the first output terminal or the second output terminal.

3. The energy storage device according to claim 2, wherein the inverter is a bidirectional inverter, the mains power received at the mains power connection terminal being supplied to the battery module through the inverter,
wherein the mains power input branch comprises:
a single-phase mains power input branch configured for single-phase mains power charging of the energy storage module; and
a split-phase mains power input branch configured for split-phase mains power charging of the energy storage module, wherein the energy storage module is operable to be charged via the single-phase mains power charging or the split-phase mains power charging.

4. The energy storage device according to claim 3, wherein the split-phase mains power input branch is electrically connected to the first output terminal, and the single-phase mains power input branch is electrically connected to the second output terminal, wherein when the first output terminal and the second output terminal output power, the power input terminal is electrically connected to the first output terminal.

5. The energy storage device according to claim 4, comprising a first alternating current bus, wherein the energy storage module and the single-phase mains power input branch are electrically connected to the second output terminal via the first alternating current bus.

6. The energy storage device according to claim 4, further comprising a second alternating current bus, wherein the energy storage module and the split-phase mains power input branch are electrically connected to the second output terminal via the second alternating current bus.

7. The energy storage device according to claim 4, wherein:
the single-phase mains power input branch further comprises a single-phase mains power input terminal and a single-phase mains power output terminal, the single-phase mains power input terminal being configured to receive single-phase mains power, and the single-phase mains power output terminal being configured to output the single-phase mains power to charge the energy storage module; and
the split-phase mains power input branch further comprises a split-phase mains power input terminal and a split-phase mains power output terminal, the split-phase mains power input terminal being configured to receive split-phase mains power, and the split-phase mains power output terminal comprising a first split-phase output terminal and a second split-phase output terminal, wherein the first split-phase output terminal is electrically connected to the first output terminal, and the second split-phase output terminal is configured to output the split-phase mains power to charge the energy storage module.

8. The energy storage device according to claim 7, further comprising a control module, wherein:
the single-phase mains power input branch comprises a single-phase switch, the single-phase switch having an end connected to the single-phase mains power input terminal, and another end connected to the single-phase mains power output terminal, wherein the control module is configured to control the single-phase switch to turn on when the single-phase mains power is received at the single-phase mains power input terminal; and
the split-phase mains power input branch comprises a split-phase switch, the split-phase switch having an end connected to the split-phase mains power input terminal, and another end connected to the split-phase mains power output terminal, wherein the control module is configured to control the split-phase switch to turn on when the split-phase mains power is received at the split-phase mains power input terminal.

9. The energy storage device according to claim 1, further comprising:
a generator input branch having a generator connection terminal, wherein the generator input branch is configured to receive generator power via the generator connection terminal to charge the energy storage module or transmit the power to the power input terminal.

10. The energy storage device according to claim 9, wherein the generator input branch further comprises a generator switch, the generator switch having an end electrically connected to the generator connection terminal, and another end connected to the energy storage module or the power input terminal.

11. The energy storage device according to claim 10, comprising:
a control module electrically connected to the generator switch, wherein the control module is configured to control the generator switch to turn on or turn off when a generator is connected to the generator connection terminal.

12. The energy storage device according to claim 11, further comprising an alternating current output terminal, wherein the energy storage module is configured to transmit the alternating current to the alternating current output terminal.

13. The energy storage device according to claim 1, wherein the housing has an openable and closable outer cover, the branch switch is detachably disposed between the power input terminal and the load connection terminal, and the branch switch is exposed when the outer cover is opened for disassembly, assembly and operation of the branch switch.

14. The energy storage device according to claim 2, further comprising a first main switch, the first main switch having an end electrically connected to the power input terminal, and another end selectively connectable to the first output terminal or the second output terminal.

15. The energy storage device according to claim 14, further comprising a control module, wherein the control module is configured to control the first main switch to be electrically connected to the second output terminal when power fails at the first output terminal.

16. The energy storage device according to claim 14, further comprising a control module, wherein the control module is configured to control the first main switch to be electrically connected to the second output terminal when an electric quantity of the battery module is greater than a predetermined threshold.

17. The energy storage device according to claim 14, wherein the mains power input branch comprises a split-phase mains power input branch, the split-phase mains power input branch further comprising a split-phase mains power input terminal and a split-phase mains power output terminal, wherein the split-phase mains power input terminal is configured to receive split-phase mains power, and the split-phase mains power output terminal comprises a first split-phase output terminal and a second split-phase output terminal, the first split-phase output terminal being electrically connected to the first output terminal, and the second split-phase output terminal being configured to output the split-phase mains power to charge the energy storage module.

18. The energy storage device according to claim 17, further comprising a second main switch, the second main switch having an end electrically connected to the inverter, and another end selectively connectable to either the second split-phase output terminal or the second output terminal.

19. The energy storage device according to claim 18, further comprising a control module, wherein the control module is configured to:
control the second main switch to be electrically connected to the second output terminal when power fails at the split-phase mains power output terminal; or
control the second main switch to be electrically connected to the second output terminal when an electric quantity of the battery module is greater than a predetermined threshold.

20. The energy storage device according to claim 2, wherein the mains power input branch comprises a split-phase mains power input branch, and the inverter is a split-phase inverter, wherein the split-phase mains power input branch is electrically connected to the first output terminal, and the split-phase inverter is electrically connected to the second output terminal.
